(19) United States
(12) Patent Application Publication
(10) Pub. No.: US 2006/0147680 A1
(43) Pub. Date: Jul. 6, 2006

(54) Film made of aluminium material

(76) Inventor: Josef Kothmeier, Roth (DE)

Correspondence Address: PROSKAUER ROSE LLP;PATENT DEPARTMENT, 1585 BROADWAY, NEW YORK, NY, 10036-8299, US

(21) Appl. No.: 10/516,191

(22) PCT Filed: May 22, 2003
(86) PCT No.: PCT/EP03/05532

§ 371 Date: Jun. 28, 2005

(30) Foreign Application Priority Data
May 29, 2002 (DE) 1022421317

(51) Int. Cl. B32B 3/12

(52) U.S. Cl. 428/178

(57) ABSTRACT

The invention relates to a film made of an aluminum material with a sealable coating 5, wherein the sealable coating 5 is suitable for establishing a bond with a transparent, pre-shaped plastic film 2 via sealing. Such a film is improved relative to its printability and subsequent sealability by having the sealable coating 5 contain fine-grained constituents 6.

The invention relates to a film made of an aluminum material with a sealable coating, wherein the sealable coating is suitable for establishing a connection bond with a transparent, pre-shaped plastic film via sealing, as well as a blister pack, in particular for tablets.

It is known from prior art to provide tablet blister packs with a calendar or daily checklist on the side of the aluminum strip furnished to cover a transparent, pre-shaped plastic film in order to document tablet ingestion, e.g., for daily dose products. Lettering the side of the aluminum film facing away from the product is disadvantageous with respect to ease of use, since the user must first align the product to be pushed through and the imprint, usually by turning the blister pack several times.

In order to prevent this, it is already known to print the calendar or daily checklist on the side of the aluminum strip facing the product. This imprint (e.g., Monday, Tuesday, . . . ) must be legible through the pre-shaped plastic film, and cannot be scrunched during the thermal sealing process when sealing the aluminum strip on the pre-shaped plastic film. This has previously not been ensured during the use of printing inks for digital printing.

Proceeding from the prior art described above, the object of the present invention is to provide a film made of aluminum material or a blister pack, in particular for tablets, which ensures perfect legibility of digital print even after sealing, in particular toner print, by means of an electrophotographic printer (e.g., compare EP 0 718 719 B1) on the side of the aluminum strip facing the product.

In a first instruction of the invention, the object derived and explained above is achieved for a film made of an aluminum material by having the sealable coating contain fine-grained constituents. Adding fine-grained constituents to the sealable coating ensures that printing inks used during digital printing bond very well with the sealable coating, and do not noticeably ,,smear” even in the sealing process.

In a particularly advantageous embodiment of the first instruction of the invention, the fine-grained constituents take the form of dispersed silicic acid. In particular, the dispersed silicic acid improves adhesion of the printing inks for digital printing on the sealable coating.

Particularly good sealing properties are ensured in another embodiment of the film according to the first instruction of the invention by having the sealable coating consist essentially of modified polypropylene.

In a second instruction of the invention, the object derived and explained above is achieved by means of a blister pack, in particular for tablets, which has a transparent, pre-shaped plastic film and a film made of aluminum material with a sealable coating according to the first instruction of the invention, wherein the plastic film is bonded with the film made of aluminum material via sealing.

For this blister pack according to the second instruction of the invention, using a sealable coating according to the first instruction of the invention ensures that the imprint applied via digital printing remains clearly legible on the transparent, pre-shaped plastic film after the film made of aluminum material has been sealed.

There are numerous ways in which to configure and further develop the film made of aluminum material according to the first instruction of the invention or the blister pack, in particular for tablets, according to the second instruction of the invention. To this end, for example, reference is made to the claims subordinate to claim 1 on the one hand, and to the description of an exemplary embodiment for a blister pack according to the second instruction of the invention in conjunction with the drawing on the other.

The single FIGURE in the drawing shows an exemplary embodiment of a blister pack for tablets according to the second instruction of the invention.

The single FIGURE depicts an exemplary embodiment of a blister pack for tablets 1, in which the blister pack has a transparent, pre-shaped plastic film 2 and an aluminum strip 3, here consisting of a film 4 made of an aluminum material and a sealable coating 5.

In the exemplary embodiment shown, the transparent, pre-shaped plastic film 2 has already been bonded with the aluminum strip 3 via sealing.

In the first instruction of the invention, the sealable coating 5 has dispersed silicic acid 6 as the fine-grained constituents.

A modified polypropylene with a melting range of 160°-220° and a layer thickness of 0.5-5 g/m² is preferably used as the base material for the sealable coating 5.

In particular a COC composite film preferably encompassing at least an ethylene-vinyl alcohol (EVOH) film layer and at least one cyclo-olefin copolymer (COC) film layer is suitable as the transparent, pre-shaped plastic film 2, wherein at least two additional outer film layers are provided to protect the EVOH-COC film layers, and are preferably resistant to unpolar media, e.g., two film layers made of polypropylene (e.g., compare German Patent Application 101 64 015).

Before sealing the plastic film 2 on the aluminum strip 3, the side of the aluminum strip 3 facing the product is provided with an imprint 7 via digital printing. This imprint remains easily legible even after sealing with rollers. In this case, the printing process can take place in-line during packaging, or beforehand in a digital printing machine.

As a rule, the side of the aluminum strip 3 facing away from the product is also provided with a coating or lacquering, although this is not shown here.

1. A film made of an aluminium material, with a sealable coating, wherein the sealable coating is suitable for establishing a bond with a transparent, pre-shaped plastic film via sealing, wherein
the film is at least partially imprinted on the side of the film facing the sealable coating, and that the sealable coating contains fine-grained constituents.

2. The film according to claim 1, wherein
the fine-grained constituents take the form of dispersed silicic acid.

3. The film according to claim 1, wherein
the sealable coating essentially consists of modified polypropylene.

4. A blister pack, in particular for tablets, with a transparent, pre-shaped plastic film and a film made of an aluminium material with a sealable coating according to claim 1, wherein the plastic film is bonded with the film made of an aluminium material via sealing.
